(19) United States
(12) Patent Application Publication
(10) Pub. No.: US 2025/0355140 A1
(43) Pub. Date: Nov. 20, 2025

(54) POLARIZING SHEET

(71) Applicant: MITSUBISHI GAS CHEMICAL COMPANY, INC., Tokyo (JP)

(72) Inventors: Kota OKAZAKI, Tokorozawa-shi (JP); Yuya MATSUNO, Tokyo (JP); Masayuki AKAKI, Tokorozawa-shi (JP); Hideaki KIMURA, Tokorozawa-shi (JP)

(73) Assignee: MITSUBISHI GAS CHEMICAL COMPANY, INC., Tokyo (JP)

(21) Appl. No.: 18/996,249

(22) PCT Filed: Jul. 13, 2023
(86) PCT No.: PCT/JP2023/025922

§ 371 Date: Jan. 17, 2025

(30) Foreign Application Priority Data
Jul. 20, 2022 (JP) 2022-115936

(51) Int. Cl. G02B 1/14; B32B 7/12; B32B 27/08; B32B 27/30; B32B 27/34; B32B 27/36

(52) U.S. Cl. CPC G02B 1/14; B32B 7/12; B32B 27/08; B32B 27/306; B32B 27/34; B32B 27/365; B32B 2307/516; B32B 2307/7376; B32B 2551/00

(57) ABSTRACT

A polarizing laminate includes a uniaxially stretched polyvinyl alcohol resin film as a polarizing film, with transparent protective layers disposed on both sides via adhesive layers, wherein: in optical distortion measured based on MIL-DTL-43511D, the difference between the maximum and minimum widths of gaps (slit spacing) formed by two adjacent slits in the polarizing laminate is 1.05 mm or less.

### TECHNICAL FIELD

The present invention relates to polarizing films, polarizing sheets, and methods for manufacturing thereof, which are used in polarizing lenses for applications such as sunglasses and goggles. Specifically, it pertains to methods for manufacturing polarizing films with extremely low optical distortion, the polarizing films themselves, and polarizing sheets utilizing these films.

### BACKGROUND ART

It is well known that polarizing lenses for sunglasses are made by laminating a transparent protective sheet via an adhesive to both sides of a polarizing film made of a resin base material such as polyvinyl alcohol oriented substantially in one direction and adsorbing a dichroic dye or the like, then bending the polarizing lens into a spherical or aspherical surface or injection-molding a transparent resin for lens onto the concave surface of the aforementioned bending polarizing lens. Polarizing lenses for sunglasses are well known. Polycarbonate, polyamide, polyacetyl cellulose, etc. are also known as transparent protective sheets for polarizing lenses made in this way, and different types are used depending on the characteristics of each resin. For example, a transparent protective sheet made of polycarbonate can provide polarized lenses with excellent heat resistance and impact resistance, while a transparent protective sheet made of polyamide can provide polarized lenses with excellent chemical resistance.

These transparent protective sheets are required to have low optical distortion to avoid altering the polarization direction of the polarizing film. For this purpose, manufacturing methods have been proposed that prevent the formation of surface irregularities during the production of transparent protective films. Furthermore, as protective films for polarizing separation sheets, it is preferable to have a low retardation value to minimize disruption of the polarization direction, with a retardation value of 20 nm or less being desirable (Reference 1). On the other hand, depending on the properties of the resin used for the protective layer of the polarizing film, there are protective sheets for polarizing films that are intentionally manufactured to maintain high retardation values to address issues such as interference fringes caused by high birefringence (Reference 2).

### Background Art

### CITATION LIST

Patent Document 1: JP-A-2012-092217
Patent Document 2: WO2011/105055A1

### SUMMARY OF INVENTION

### Problems to be Solved by Invention

On the other hand, eyewear used by individuals engaged in specialized tasks, such as pilots, requires more specific optical properties compared to those generally available on the market. For example, there are standards used for procuring equipment required by the U.S. military, commonly referred to as MIL standards. Regarding optical distortion in these MIL standards, the acceptability of products is determined by visually inspecting the width of slits along the transmission axis of polarizing lenses. However, polarizing sheets for manufacturing polarizing lenses with such optical properties and efficient methods for producing such polarizing sheets have not been proposed until now.

### Solution to Problems

To address the above issues, the inventors of the present application conducted extensive research and discovered that reducing the in-plane variation in the retardation value of the transparent protective sheet in polarizing sheets enables the efficient production of polarizing sheets with extremely low optical distortion that meet MIL standards. This finding led to the development of the present invention.

Accordingly, the present invention provides a polarizing laminate comprising a polarizing film made of a uniaxially stretched polyvinyl alcohol resin film, with transparent plastic sheets as protective layers disposed on both sides via adhesive layers, wherein: in optical distortion measured based on MIL-DTL-43511D, the difference between the maximum and minimum widths of gaps (slit spacing) formed by two adjacent slits in the polarizing laminate is 1.05 mm or less.

Another aspect of the present invention is a polarizing laminate as described above or a combination thereof, characterized in that the difference between the maximum and minimum widths of gaps (slit spacing) formed by two adjacent slits in the protective layer is 0.75 mm or less.

Another aspect of the present invention is a polarizing laminate as described above or a combination thereof, characterized in that the retardation value of at least one protective layer is 3000 to 5000 nm.

Another aspect of the present invention is a polarizing laminate as described above or a combination thereof, characterized in that the retardation value of the protective layer on the opposite side is less than 100 nm.

Another aspect of the present invention is a polarizing laminate as described above or a combination thereof, characterized in that the difference between the maximum and minimum retardation values of at least one protective layer in the polarizing laminate is less than 300 nm.

Another aspect of the present invention is a polarizing laminate as described above or a combination thereof, characterized in that the thickness of the protective layer is greater than 100 μm.

Another aspect of the present invention is a polarizing laminate as described above or a combination thereof, characterized in that the thickness of the adhesive layer is less than 40 μm.

Another aspect of the present invention is a polarizing laminate as described above or a combination thereof, characterized in that the protective layer is made of polycarbonate resin or polyamide resin.

Another aspect of the present invention is a polarizing lens for sunglasses using the polarizing laminate as described above or a combination thereof, characterized in that, in optical distortion measured based on MIL-DTL-43511D, the difference between the maximum and minimum widths of gaps (slit spacing) formed by two adjacent slits is 1.05 mm or less.

### Effects of Invention

The present invention makes it possible to easily provide a polarizing laminate with extremely low optical distortion, equivalent to so-called military-grade standards.

### BRIEF DESCRIPTION OF THE DRAWINGS

FIG. 1 is an image showing the optical slit widths of the polarizing laminate according to the present invention compared with the optical slit widths in a comparative example.

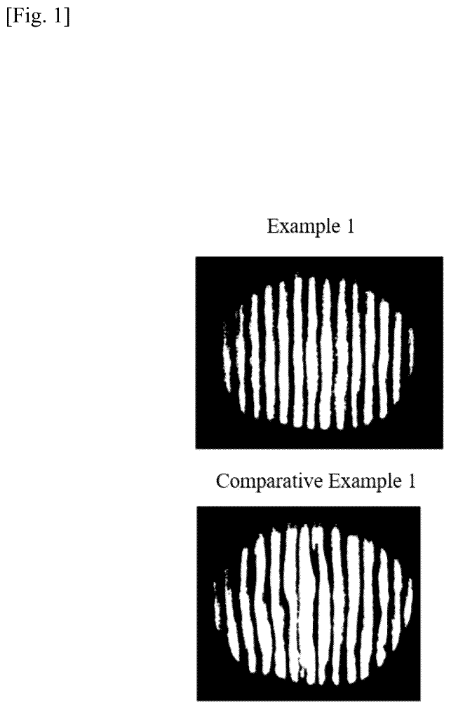

### DESCRIPTION OF EMBODIMENTS

Hereinafter, embodiments of the present invention will be described.

### (Polarizing Film Layer))

The polarizing film is obtained by swelling a resin film, which serves as the base material, in water, and then impregnating it with a dyeing solution containing the dichroic organic dye of the present invention while stretching it in one direction, thereby dispersing the dichroic dye in an oriented state within the base resin and imparting polarizing properties and the desired color tone to the film.

As a resin to be a base material of the polarizing film used at this time, polyvinyl alcohols are used, and as the polyvinyl alcohols, polyvinyl alcohol (hereinafter referred to as PVA), polyvinyl alcohol in which a trace amount of an acetic acid ester structure of PVA remains, polyvinyl formal which is a PVA derivative or an analog, polyvinyl acetal, a saponified product of an ethylene-vinyl acetate copolymer, and the like are preferable, and PVA is particularly preferred.

Further, from the viewpoint of stretchability and film strength, PVA preferably has a weight average molecular weight of 50,000 to 350,000, more preferably 100,000 to 300,000, and particularly preferably 150,000 or more. A stretch ratio for stretching a PVA film is 2 to 8 times, preferably 3 to 6.5 times, and particularly preferably 3.5 to 4.5 times from the viewpoint of a dichroic ratio and film strength after stretching. The thickness of the stretched PVA film is not particularly limited; however, from the perspective of handling it without integrating it with a protective film, a thickness of 20 μm or more and approximately 50 μm or less is preferred.

A typical manufacturing process when the PVA film is used as the base material film includes the steps of:
(1) the PVA is swollen in water while being washed to remove impurities;
(2) while appropriately stretching the PVA film;
(3) dyeing the PVA film in a dyeing tank;
(4) crosslinking or chelating the PVA film with boric acid or a metal compound in a treatment tank; and
(5) drying the PVA film. Note that the steps (2) and (3) (optionally (4)) may be appropriately changed in order or performed simultaneously.

First, in a swelling/water washing step of the step (1), the PVA film that easily breaks in a dry state at room temperature can be uniformly softened and stretched by absorbing water. Further, the step is a step of removing a water-soluble plasticizer or the like used in a step of producing the PVA film, or a step of preliminarily adsorbing an additive as appropriate. At this time, the PVA film does not sequentially and uniformly swell, and variations always occur. Even in this state, it is important to devise such that a force as small as possible is uniformly applied so as to prevent local stretching or insufficient stretching and to suppress the occurrence of wrinkles and the like. In addition, in this step, it is most desirable to simply uniformly swell, and excessive stretching or the like is not performed as much as possible because it causes unevenness.

In Step (2), stretching is usually performed so that the stretch ratio is 2 to 8 times. In the present invention, since good processability is important, it is preferable to select the stretch ratio from 3 to 6.5 times, particularly 3.5 to 4.5 times, and maintain orientation even in this state. In a stretched and oriented state, when a time in water and a time until drying are long, orientation relaxation proceeds, and thus from the viewpoint of maintaining higher performance, it is preferred that a stretching treatment is set to be shorter, and after stretching, moisture is removed as soon as possible, that is, the film is immediately guided to a drying step and dried while avoiding an excessive heat load. The stretching ratio in this application refers to the stretching ratio based on the original polyvinyl alcohol resin film.

Dyeing in Step (3) is performed by adsorbing or depositing dye on a polymer chain of an oriented polyvinyl alcohol-based resin film. From this mechanism, dyeing can be performed before, during, or after uniaxial stretching, there is no significant difference, and an interface, which is a highly regulated surface, is most easily oriented, and it is preferable to select conditions that take advantage of this. Temperature is usually selected from high temperatures of 40° C. to 80° C. for demand of high productivity, but in the present invention, it is usually selected from 25° C. to 45° C., preferably 30° C. to 40° C., and particularly 30° C. to 35° C.

Step (4) is performed for improving heat resistance and improving water resistance and organic solvent resistance. Treatment with the boric acid of the former improves heat resistance by crosslinking between PVA chains, but cross-linking treatment can be performed before, during, or after uniaxial stretching of the polyvinyl alcohol resin film, and there is no significant difference. Further, the metal compound of the latter mainly forms and stabilizes a chelate compound with a dye molecule, and chelation treatment is usually carried out after dyeing or simultaneously with dyeing.

As the metal compound, there are transition metals belonging to any one of the fourth period, the fifth period, and the sixth period, which are confirmed to have the above heat resistance and solvent resistance effect in the metal compound, but metal salts such as acetates, nitrates, and sulfates of fourth period transition metals such as chromium, manganese, cobalt, nickel, copper and zinc are preferred from the viewpoint of price. Among them, compounds of nickel, manganese, cobalt, zinc, and copper are more preferred because they are inexpensive and excellent in the above effect.

As a more specific example, manganese acetate (II) tetrahydrate, manganese acetate (III) dihydrate, manganese nitrate (II) hexahydrate, manganese sulfate (II) pentahydrate, cobalt acetate (II) tetrahydrate, cobalt nitrate (II) hexahydrate, cobalt sulfate (II) pentahydrate, nickel acetate (II) tetrahydrate, nickel nitrate (II) hexahydrate, nickel sulfate (II) hexahydrate, zinc acetate (II), zinc sulfate (II), chromium nitrate (III) nonahydrate, copper acetate (II) monohydrate, copper nitrate (II) trihydrate, copper sulfate (II) pentahydrate, etc., can be listed. Among these metallic compounds, anyone may be used alone, or two or more may be combined.

From the viewpoint of imparting heat resistance and solvent resistance to the polarizing film, content rate of the metal compound and boric acid in the polarizing film is preferably 0.2 to 20 mg, more preferably 0.2 to 2 mg as a metal of the metal compound per 1 g of the polarizing film. As a more specific example, the concentration of the metal compound impregnated in the polarizing film is from 200 ppm to 2500 ppm, preferably from 200 ppm to 2000 ppm, more preferably from 400 ppm to 1800 ppm, even more preferably from 800 ppm to 2300 ppm, and most preferably from 600 ppm to 1600 ppm. When the concentration of the metal compound is less than 200 ppm, there is a tendency for color unevenness to occur, and when it exceeds 2500 ppm, issues with moisture-heat resistance arise.

As described above, when a metal compound is impregnated into the polarizing film in a treatment tank, it is believed that a chelate is formed between the dye molecules and the polarizing film, thereby suppressing changes in dye orientation. If an excessive amount of the metal compound is added, the excess metal compound not used for chelate formation reacts with the dye molecules, making it difficult to adjust the color tone. On the other hand, if no metal compound is added, the dichroic ratio decreases, necessitating the use of high-dichroic-ratio dyes to compensate. This leads to higher orientation of the polarizing film under humid and hot environments, resulting in significant color changes. Therefore, adding an appropriate amount of metal compound necessary for chelate formation is essential for producing polarizing films.

In the present invention, the content of boric acid is preferably 0.3 to 30 mg, and more preferably 0.5 to 10 mg, in terms of boron. The composition of the treatment solution used in the process is set to satisfy the above content levels. Typically, the concentration of the metal compound is preferably 0.5 to 30 g/L, and the concentration of boric acid is preferably 2 to 20 g/L.

The contents of the metal and boron contained in the polarizing film can be analyzed by atomic absorption spectrometry.

As for the temperature, the same conditions as for dyeing are usually employed, but it is usually selected from 20° C. to 70° C., preferably 25° C. to 45° C., more preferably 30° C. to 40° C., and particularly 30° C. to 35° C. Further, the time is usually selected from 0.5 to 15 minutes.

In Step (5), a dyed uniaxially stretched PVA film that has been stretched, dyed, and appropriately treated with boric acid or the metal compound is dried. The PVA film exhibits heat resistance corresponding to the amount of moisture it contains, and when the temperature increases in a state of containing a large amount of moisture, disturbance from a uniaxially stretched state occurs in a shorter time, and the dichroic ratio decreases.

The drying proceeds from a surface of the PVA film and is preferably performed from both surfaces of the PVA film, and preferably performed while removing water vapor by dry air blowing. In addition, as is well known, from the viewpoint of avoiding excessive heating, a method of immediately removing evaporated moisture to promote evaporation is preferred from the viewpoint of being able to perform drying with a temperature rise suppressed, and air blow drying is carried out for 1 to 120 minutes, and preferably 3 to 40 minutes, at a temperature of 70° C. or higher, and preferably 90° C. to 120° C., from a range of dry air temperature equal to or lower than a temperature at which the polarizing film in a dry state is not substantially discolored.

At this stage, the water content of the polarizing film is preferably 5% or less. During the drying process, it is difficult to achieve a water content below 2%, and this is also undesirable from the perspective of the strength of the polarizing film. The preferable range of water content is from 2.5% to 5.0%.

In the present invention, the dye is not particularly limited as long as it can be absorbed and oriented on a PVA polarizing film. For example, when dyeing is performed using a dichroic organic dye composition and a coloring organic dye composition, a wide range of transmittance can be selected, with the upper limit being the transmittance of the PVA polarizing film dyed with the dichroic organic dye composition, and the lower limit being the transmittance of the PVA polarizing film dyed with the coloring organic dye composition.

Furthermore, the color tone is primarily adjusted using the coloring organic dye composition, allowing for a wide range of color tones to be achieved by changing the mixing ratio without substantially considering changes in the degree of polarization.

### (Adhesive Layer)

To form a polarizing laminated sheet by laminating a polarizing film and a transparent protective sheet, an adhesive layer is interposed between the polarizing film and the transparent protective sheet. Typically, materials used for the adhesive layer in polarizing laminated sheets include polyvinyl alcohol resin-based materials, acrylic resin-based materials, urethane resin-based materials, polyester resin-based materials, melamine resin-based materials, epoxy resin-based materials, and silicone-based materials.

In the present application, considering the stability during thermal bending processes and injection molding processes, thermosetting materials are preferred. Particularly, a two-component thermosetting urethane resin composed of a polyurethane prepolymer and a curing agent is preferred.

The polyurethane prepolymer is a compound obtained by reacting a diisocyanate compound with a polyoxyalkylene diol at a certain ratio, and is a compound having isocyanate groups at both ends. As the diisocyanate compound used in the polyurethane prepolymer, diphenylmethane-4,4′-diisocyanate, tolylene diisocyanate, hexamethylene diisocyanate, isophorone diisocyanate, 4,4′-dicyclohexylmethane diisocyanate, lysine isocyanate, and hydrogenated xylylene diisocyanate can be used, but diphenylmethane-4,4′-diisocyanate is preferred. As the polyoxyalkylene diol, polypropylene glycol, polyethylene glycol, and polyoxytetramethylene glycol can be used, but polypropylene glycol having a degree of polymerization of 5 to 30 is preferably used. A molecular weight of the polyurethane prepolymer is not particularly limited, but is usually a number average molecular weight of 500 to 5000, preferably 1500 to 4000, and more preferably 2000 to 3000.

On the other hand, the curing agent is not particularly limited as long as it is a compound having two or more hydroxyl groups, and examples thereof include a polyurethane polyol, a polyether polyol, a polyester polyol, an acrylic polyol, a poly butadiene polyol, and a polycarbonate polyol, and among them, a polyurethane polyol having a hydroxyl group at a terminal thereof obtained from a specific isocyanate and a specific polyol is preferred. In particular, a polyurethane polyol having hydroxyl groups at least at both ends and derived from a diisocyanate compound and a polyol is preferred. As the diisocyanate compound, diphenylmethane-4,4′-diisocyanate, tolylene diisocyanate, hexamethylene diisocyanate, isophorone diisocyanate, 4,4′-dicyclohexylmethane diisocyanate, lysine isocyanate, and hydrogenated xylylene diisocyanate can be used, but tolylene diisocyanate is preferably used. As the polyol, one obtained by reacting trimethylolpropane or the like with ethylene oxide or propylene oxide can be used, and a polypropylene glycol derivative having a polymerization degree of 5 to 30 is preferably used. A molecular weight of the curing agent is not particularly limited, but is usually a number average molecular weight of 500 to 5000, preferably 1500 to 4000, and more preferably 2000 to 3000.

These polyurethane prepolymers and curing agents can use solvents such as ethyl acetate and tetrahydrofuran for viscosity modulation. In addition, in a case of providing a light control function to the adhesive layer, use of the solvent is an effective method for uniformly dispersing the photochromic compound in the urethane resin.

### (Protective Layer)

The transparent plastic sheet, serving as the protective layer in the polarizing laminated sheet of the present invention, typically has a thickness of 0.1 to 1 mm. It may be a single-layer sheet or a multilayer sheet produced by co-extrusion methods, such as an aromatic polycarbonate/polyacrylate co-extruded sheet. Furthermore, the polarizing laminated sheet of the present invention is generally provided with protective films on both surfaces, punched into individual lens shapes, then thermally bent. After the surface protective films are removed, the sheet is mounted in an injection molding die, making it suitable for manufacturing injection-molded polarizing lenses integrated with molten resin.

As for the resin used in the transparent plastic sheet, examples include transparent resins such as aromatic polycarbonate, amorphous polyolefin, polyacrylate, polysulfone, cellulose acetate, polystyrene, polyester, polyamide, and mixtures thereof. Among these, cellulose acetate is essential for the production of the most common polarizing films. Aromatic polycarbonate resins are preferred for their mechanical strength and impact resistance, while polyolefin, polyacrylate, and polyamide are preferred for their chemical resistance. Additionally, polyacrylate and polyamide are notable for their dyeability after lens molding.

Aromatic polycarbonate sheets are preferably made from polymers manufactured by known methods using bisphenol compounds, such as 2,2-bis(4-hydroxyphenyl)alkanes or 2,2-(4-hydroxy-3,5-dihalogenophenyl)alkanes, from the perspectives of film strength, heat resistance, durability, and bending workability. The polymer backbone may include structural units derived from aliphatic diols or structural units containing ester bonds. Particularly preferred are aromatic polycarbonates derived from 2,2-bis(4-hydroxyphenyl) propane. The molecular weight of the aromatic polycarbonate is preferably in the range of 12,000 to 40,000 in terms of viscosity-average molecular weight, and more preferably in the range of 20,000 to 35,000. However, aromatic polycarbonates have a large photoelastic constant, making them prone to the occurrence of colored interference fringes caused by birefringence due to stress or orientation.

The alicyclic polyester resin of the present invention, used as a sheet or film for the protective layer in compositions with aromatic polycarbonate, is obtained by a known method. For example, it is produced by esterification or transesterification reactions between a dicarboxylic acid component, represented by 1,4-cyclohexanedicarboxylic acid, and a diol component, represented by 1,4-cyclohexanedimethanol, optionally with small amounts of other components. Subsequently, a polymerization catalyst is appropriately added, and the reaction vessel is gradually depressurized to perform a polycondensation reaction.

Specific examples of alicyclic dicarboxylic acids or their ester-forming derivatives include 1,2-cyclohexanedicarboxylic acid, 1,3-cyclohexanedicarboxylic acid, 1,4-cyclohexanedicarboxylic acid, 1,4-decalinyldicarboxylic acid, 1,5-decalinyldicarboxylic acid, 2,6-decalinyldicarboxylic acid, 2,7-decalinyldicarboxylic acid, and their ester-forming derivatives.

The polyamide resin is desirably one referred to as amorphous polyamide or microcrystalline polyamide from the viewpoint of transparency and molding processability, and preferably one that can be injection molded as described later. That is, the polyamide resin can be suitably used as long as it is thermoplastic, exhibits melt fluidity capable of being molded at a thermal decomposition temperature or lower, and has an appropriate glass transition temperature (Tg).

When amorphousness is a condition, an amount of crystalline repeating units is limited, and examples of molecular structures that inhibit crystallinity include structures that provide steric hindrance, and branched structures, introduction of substituents, and bulky molecular structures such as cycloalkanes are used. When moderate heat resistance is a condition, a structure having a large enthalpy in the repeating unit (unit molecular chain length) or a structure that restricts molecular motion within the repeating unit and between the repeating units is essential, and a typical example of the former is aromatic, and as a synthetic product that is an example of the latter, cycloalkane, cycloalkene, or the like having a structure obtained by hydrogenating an unsaturated bond of an aromatic nucleus are used. In addition, since those having an alicyclic structure have heat resistance and a molecular structure that inhibits crystallinity as described above, it can be said that they are useful materials for forming a functional sheet for sunglasses in which the polyamide to be subjected to heat bending or the like is used as the protective layer.

The polyamide generally has a structural unit derived from monomers such as diamines, dicarboxylic acids, and aminocarboxylic acids. In principle, aromatic polyamide or alicyclic polyamide is produced by making aromatic or alicyclic constitutional units derived from at least one type of monomer constituting all-aliphatic polyamide. All or part of these monomers are aromatic or alicyclic, a partially aromatic polyamide, an aromatic partially alicyclic polyamide, a partially aromatic partially alicyclic polyamide, a partially aromatic partially alicyclic polyamide, a partially aromatic alicyclic polyamide, a partially aromatic alicyclic polyamide, a partially alicyclic polyamide or the like, or a combination thereof can be used for the claimed invention, and a polyamide having an alicyclic structure can be suitably used as one of typical examples of amorphous polyamides having amorphousness and moderate heat resistance. Note that in consideration of optical characteristics such as retardation described later, it is desirable to include an aromatic moiety.

As a matter of course, additives such as lubricants and antioxidants are appropriately incorporated into the polyamide resin used in the present invention to address issues such as oxidative degradation and processing defects of the polyamide. Known transparent polyamide resins for lenses are included, with a heat deflection temperature, an indicator of heat resistance, ranging from 100° C. to 170° C. Examples include aromatic polyamide resins, alicyclic polyamide resins, aliphatic polyamide resins, and copolymers thereof. Among these, alicyclic polyamide resins are preferred for their balance of mechanical strength, chemical resistance, and transparency. However, a combination of two or more polyamide resins may also be used. Examples of such polyamide resins include GLILAMID TR FE5577, XE 3805 (manufactured by EMS), NOVAMID X21 (manufactured by Mitsubishi Engineering Plastics), and Toyobo Nylon T-714E (manufactured by Toyobo).

(Meth)acrylic resins include homopolymers of various (meth)acrylic acid esters, such as polymethyl methacrylate (PMMA) and methyl methacrylate (MMA), as well as copolymers of PMMA or MMA with one or more other monomers. Additionally, mixtures of multiple types of these resins may also be used. Among these, (meth)acrylates containing cyclic alkyl structures are preferred for their excellent properties, such as low birefringence, low moisture absorption, and high heat resistance.

Examples of such (meth)acrylic resins include ACRYPET (manufactured by Mitsubishi Rayon Co., Ltd.), DELPET (manufactured by Asahi Kasei Chemicals Co., Ltd.), and PARAPET (manufactured by Kuraray Co., Ltd.).

In the polarizing laminate of the present invention, it is desirable to place a protective layer with a retardation value that does not impede the function of the polarizing film layer provided in the inner layer, at least at the position that will become the convex surface after lens processing.

When aiming for such low retardation, films produced by methods such as the casting method, which are less likely to promote molecular orientation, can be suitably used as the protective layer. However, even in the casting process, care must be taken to avoid the generation of unnecessary stress during the take-up process, which could result in an excessively high retardation value.

Alternatively, in a method other than the method of keeping the retardation value small, conversely, the protective layer having an extremely large retardation value of, for example, 1300 nm or more, preferably 2000 nm or more, and more preferably 3000 nm or more is disposed on the convex surface after being processed into the lens, so that phenomena such as “color unevenness” and “polarization leakage” can be dealt with by making the phenomena indistinguishable to the naked eye. When the retardation value is extremely increased as described above, it is necessary to subject the protective layer made of the polyamide resin to the stretching treatment. In that case, a method is desirable in which a sheet molded to a certain thickness, for example, 100 μm or more, preferably 150 μm or more, more preferably 200 μm or more, and still more preferably 300 μm or more by a melt extrusion method or the like is stretched to form the protective film having a desired retardation value and thickness. Note that in the present invention, the retardation value is an in-plane retardation value. It is within the knowledge of those skilled in the art that the in-plane retardation value can be derived from a refractive index in a slow axis direction, a refractive index in a fast axis direction, and the thickness of the film when an incident linearly polarized light is decomposed into a slow axis and a fast axis. Note that in the present disclosure, the retardation value is a value measured at 590 nm. Examples of a measuring apparatus include a retardation measuring apparatus: RETS-100 manufactured by Otsuka Electronics Co., Ltd.

Examples of a method for stretching a film molded by the melt extrusion method to increase the retardation value include a draw stretching method of drawing the film while stretching the film at the time of drawing the film, and an off-line stretching method of winding the film once after molding and separately stretching the film. In a melt extrusion molding method, for example, a polyamide sheet can be manufactured by melt-mixing the polyamide resin or the resin constituting the protective layer with an extruder or the like, extruding the mixture from a die (for example, a T-die or the like), and cooling the mixture. A resin temperature at the time of melting and molding (melt molding) the polyamide resin or the resin constituting the protective layer can be usually selected from a temperature range of about 120° C. to 350° C., and is, for example, about 130° C. to 300° C., preferably 150° C. to 280° C., and more preferably about 160° C. to 250° C. At this time, the stretching treatment can be performed by increasing the drawing speed more than a speed of a cooling roll.

The specific method of stretching is not particularly limited. To suppress stretching irregularities, it is preferable to maintain a consistent resin temperature by appropriately heating the rolls in the stretching section using tools such as mold temperature controllers. Generally, stretching near the glass transition temperature (Tg) of the resin used for the protective layer enables maintaining an appearance suitable for sunglasses sheets. When the resin temperature is lower than the Tg of the resin used, stretching irregularities are likely to occur, leading to uneven patterns between stretched and non-stretched areas. On the other hand, if stretching is performed at temperatures higher than the Tg, it can cause adhesion of the transparent plastic film to the rolls, resulting in marks when the film is peeled off the rolls.

It is necessary to select the conditions of the rolls and other temperature control devices while considering the relationship with retardation, which will be described later. Note that the Tg referred to in the present invention indicates the midpoint temperature on the Tg curve when measured by DSC, among the onset, midpoint, and endpoint temperatures.

The resin temperature of the protective layer during stretching is also related to the imparting of retardation. If the film's resin temperature during stretching is lower than the Tg of the resin used, higher retardation is more easily imparted. Conversely, as the temperature increases, it becomes more difficult for retardation to manifest. Additionally, it is preferable to cool the film as quickly as possible after stretching. This helps to fix the retardation as well as the angle between the slow axis and the fast axis. However, when stretching is performed at temperatures lower than the Tg, issues such as shrinkage after sheet molding may arise. Therefore, it is essential to select stretching temperature conditions with this consideration in mind. On the other hand, when stretching is performed at resin temperatures higher than the Tg, the effect of neck-in during stretching becomes more significant, potentially affecting the thickness distribution and causing greater variations in retardation and fast-axis angles. In such cases, care must be taken, such as avoiding excessively high stretch ratios.

When a resin molded by the melt extrusion method is stretched to form the protective layer, it is preferable to use a resin with a high intrinsic birefringence value. This makes it easier to achieve higher retardation under lower stress and to maintain retardation even when stretching is performed at resin temperatures higher than the Tg. The intrinsic birefringence value varies depending on the composition or type of resin, as well as the desired retardation value. Therefore, it is essential to appropriately adjust the stretching ratio during the stretching process. Generally, a minimum stretch ratio of at least 1.1 times is required, preferably 1.2 times, and more preferably 1.3 times or greater. However, as the stretch ratio increases, neck-in becomes more pronounced, and the risk of breakage arises, setting practical limits from the perspective of production efficiency. Typically, the stretch ratio is around 2.2 times, preferably about 2.0 times or less.

To prevent colored interference fringes caused by the stretching of the transparent plastic sheet used as the protective layer, it is preferable for the sheet to have a retardation (Re, hereinafter referred to simply as retardation, meaning in-plane retardation) in the range of 1500 to 10,000 nm. In this case, a preferred lower limit for retardation is 2000 nm, a more preferred lower limit is 2500 nm, an even more preferred lower limit is 3000 nm, a further preferred lower limit is 3500 nm, and the most preferred lower limit is 4000 nm. Depending on the type of backlight source, if the retardation is too low, rainbow patterns may appear. The preferred upper limit is 8000 nm, a more preferred upper limit is 7000 nm, an even more preferred upper limit is 6000 nm, a particularly preferred upper limit is 5500 nm, and the most preferred upper limit is 5000 nm. Transparent plastic sheets with retardation exceeding this range tend to become too thick, making them unsuitable for use in the present invention.

The transparent plastic sheet in the polarizing sheet is preferably one with a small deviation in in-plane retardation. In the present invention, the deviation in in-plane retardation can be determined by dividing the molded or stretched transparent plastic sheet into three sections along its longitudinal direction and measuring the retardation in the central area and the areas near both ends, using these measured values as a reference.

### (Production of Functional Sheets)

The polarizing film described above serves as the functional layer. By applying the adhesive layer using a gravure coater or die coater and laminating the protective layers on both sides, followed by cutting to the desired length, the polarizing laminate of the present invention can be produced. While the lamination method is not particularly limited, it is important to maintain a sufficient discharge volume during the application of the adhesive to avoid issues such as air bubble entrapment caused by insufficient coating solution. Additionally, the tension during lamination, as well as the nip pressure of the laminating rolls, should be appropriately adjusted, taking into consideration factors such as the warping state of the sheet after lamination.

### (Production of Functional Lenses)

Next, the polarizing laminate is processed into individual lens shapes through methods such as punching, followed by bending. The processing into individual lens-shaped pieces is typically performed by punching multiple lens-shaped pieces using a punching blade made of Thomson blades, considering productivity and other factors. The shape of the individual lens pieces is appropriately selected based on the final product shape, such as sunglasses or goggles. For binocular applications, a standard lens shape is a circular disc with a diameter of 80 mm or a slit shape formed by cutting both ends of the disc to the same width perpendicular to the polarization axis. As for bending, as mentioned in the selection of the type of transparent plastic sheet used for the protective layer of the polarizing sheet, the conditions are determined based on the requirement that the layer providing functionality, including the colored polarizing film of the present invention, does not undergo substantial degradation.

When used as an injection-molded polarizing lens, the bending process is performed to conform to the surface of the mold used for injection molding. When using a protective layer made of a high-retardation sheet, the polarizing film is prone to cracks, commonly referred to as film tearing, along the stretching direction during bending. Therefore, it is necessary to select conditions that suppress the occurrence of these defects. For the bending process of the polarizing sheet, the mold temperature is preferably below the glass transition temperature of the resin used. Additionally, it is preferable that, through preheating, the temperature of the polarizing sheet immediately before bending is at least 50° C. below the glass transition temperature but less than the glass transition temperature of the resin used. More specifically, it is particularly preferred that the temperature be at least 40° C. below the glass transition temperature but less than 5° C. below the glass transition temperature.

Next, molten resin is injected to produce the injection-molded polarizing lens. The processing conditions for injection molding must ensure the production of lenses with excellent appearance. From this perspective, injection conditions must be selected to achieve highly filled molded lenses without burr formation. These conditions include injection pressure, holding pressure, metering, and molding cycle. The resin temperature should correspond to the melting temperature of the resin being used, typically selected from the range of 260-320° C. Additionally, the mold temperature should be selected from the range of at least 100° C. below the glass transition temperature (Tg) of the aromatic polycarbonate resin but below the glass transition point itself. Preferably, the mold temperature is from at least 80° C. below the Tg to less than 15° C. below the Tg, and more specifically, from at least 70° C. below the Tg to less than 25° C. below the Tg.

One embodiment of the present invention includes the bent polarizing lenses and injection-molded polarizing lenses described above. When producing injection-molded polarizing lenses through the above-mentioned processing steps, it can be readily assumed that the polarizing laminate will undergo certain levels of optical distortion due to the physical stress applied. However, the polarizing lenses of the present invention possess optical distortion that fully meets MIL standards, even after undergoing such manufacturing processes. Specifically, based on MIL-DTL-43511D, as measured by the methods described in this specification, the difference between the maximum and minimum widths of the gaps formed by two adjacent slits (slit spacing) can be controlled to 1.05 mm or less.

Next, a hard coat treatment is applied. There are no particular restrictions on the material or processing conditions for the hard coat, but it must exhibit excellent adhesion to the appearance, the resin used, and subsequent inorganic layers such as mirror coats or anti-reflective coats. The firing temperature is preferably at least 50° C. below the glass transition temperature (Tg) of the resin used in the polarizing sheet but less than the glass transition point itself. More specifically, it is preferably at least 40° C. below the Tg to less than 15° C. below the Tg, typically around 120° C. The time required for firing the hard coat generally ranges from approximately 30 minutes to 2 hours.

### EXAMPLES

The details of the present invention are explained below based on the examples.

### Example 1

### a) Preparation of Polarizing Film

Polyvinyl alcohol (manufactured by Kuraray Co., Ltd., product name: VF-PS #7500) was swelled in 35° C. water for 270 seconds and stretched to twice its original length.

Subsequently, the film was dyed in a 35° C. aqueous solution containing 0.41 g/L of dichroic dye Aizen Premium Blue 6GLH (C.I. Blue 202), 0.09 g/L of Sumilight Red 4B (C.I. Red 81), 0.03 g/L of Chrysophenine (C.I. Yellow 12), and 10 g/L of anhydrous sodium sulfate.

The dyed film was immersed in a 35° C. aqueous solution containing 2.3 g/L of nickel acetate and 4.4 g/L of boric acid for 120 seconds while being stretched to four times its original length. After this, the film was dried under tension at room temperature for 3 minutes and then heat-treated at 110° C. for 3 minutes, resulting in a polarizing film.

### b) Preparation of Protective Layer and Retardation Measurement

b-1) Polycarbonate Protective Layer

Aromatic polycarbonate resin was heat-melted and extruded through a T-die using a short-axis extruder. After cooling the extruded resin with cooling rolls, the film was wound using a take-up machine, resulting in a polycarbonate film with a thickness of 275 μm produced by the melt extrusion method. Next, the obtained polycarbonate sheet was cut into 40 cm squares, and all four sides were fixed with clamps. The sheet was held at the Tg temperature (midpoint in DSC measurement) for 20 minutes, then uniaxially stretched at a stretch ratio of 1.5× and a stretching speed of 2 m/min. After stretching, the film was cooled at room temperature for 30 minutes while maintaining tension, resulting in a polycarbonate protective film with a thickness of 200 μm. The edges approximately 25 mm from both the left and right ends in the width direction of the post-stretching film were trimmed. The trimmed film was used for retardation measurement and the production of polarizing laminated sheets.

b-2) Retardation Measurement and Deviation Determination

Retardation was measured using a WPA-200-L, manufactured by Photonic Lattice Co., Ltd. The polycarbonate protective film, measuring 300 mm in length and 295 mm in width, was divided into three sections in the width direction (L, C, R). Retardation was measured as an area measurement within a range of 70 mm per side, and the average retardation value was calculated. The standard deviation was then determined from the three measurement locations.

### c) Preparation of Polarizing Laminate

The obtained polarizing film was coated with a thermosetting polyurethane adhesive, and the 200 μm-thick polycarbonate protective film prepared earlier was laminated onto it. Similarly, another 200 μm-thick polycarbonate protective film was laminated onto the remaining side of the polarizing film. After lamination, the assembly was placed in a thermostatic chamber at 70° C. to cure the adhesive, resulting in a polarizing laminate with a 10 μm adhesive layer.

### d) Production of Polarizing Lens

A disc with a diameter of 80 mm was cut parallel on both sides of a straight line passing through its center, forming a slit shape with a width of 55 mm or a capsule or cylindrical cross-sectional shape. The uncut circular arc portions on both sides were provided with small positioning protrusions to create punched pieces for binocular lenses. The punching direction was aligned so that the longitudinal direction of the punched pieces corresponded to the absorption axis of the polarizing film. The manufactured punched pieces were then thermally bent.

For heart bending, the punched pieces were preheated using a preheater and then placed on a partial spherical female mold with a specified temperature and curvature. A silicone rubber male mold was used to press the piece while initiating vacuum suction to adhere the piece to the female mold. The male mold was then retracted, and the punched pieces adhered to the female mold were held in a hot air atmosphere at a specified temperature for a specified time before being removed. This process was performed using a continuous thermal bending device.

In this process, the preheating temperature for punched pieces with an aromatic polycarbonate protective layer was set to an ambient temperature of 136° C. The female mold was a partial sphere corresponding to an 8R curvature (radius approximately 65.6 mm) with a surface temperature of 139° C. The pressing time with the silicone rubber male mold was 4 seconds, and the suction to the female mold was maintained in a hot air atmosphere at 170° C. for 5 minutes.

The protective film of the thermally bent punched pieces produced as described above was removed, and the pieces were placed in the mold cavity of an injection molding machine. Injection molding was performed using molten aromatic polycarbonate (UV absorber added, product name: IUPILON CLS-3400, manufactured by Mitsubishi Engineering Plastics Corporation). The injection molding conditions were as follows: resin temperature of 290° C., injection filling speed of 30 mm/s, holding pressure of 30 MPa, mold temperature of 90° C., and cooling time of 30 seconds. The injection cycle was set to 70 seconds, resulting in the production of injection-molded lenses with a thickness of 2.2 mm.

### d) Optical Distortion Measurement

d-1) Visual Optical Distortion Measurement Method

According to sections 3.5.5 and 4.3.5 of MIL-DTL-43511D, the military standard established by the U.S. Department of Defense, optical distortion was measured using a Model E Distortion Tester manufactured by DATA OPTICS INC. The measurements were conducted according to the test methods specified in the standard document, and pass/fail determinations for optical distortion were made visually based on the allowable criteria described in the standard.

d-2) Optical Distortion Measurement Using an Image Discrimination System

Using the Model E Distortion Tester manufactured by DATA OPTICS INC., samples were set up according to sections 4.4.5 and FIG. 4 of MIL-DTL-43511D. The observed optical distortion was captured with a digital still camera (Panasonic LUMIX, DMC-TZ10) under the following settings: exposure 1/5, ISO sensitivity 100, and aperture (F) 6.3. The captured images were analyzed using KEYENCE's image discrimination software IV3-CP50. The slit spacing, defined as the width between adjacent slit lines in the image, was measured at three points (top, middle, and bottom) for each interval, with a total of 12 intervals measured. The difference between the maximum and minimum widths for each interval was quantified as the optical distortion. For polarizing laminates, a slit spacing of less than 1.05 mm was considered acceptable. For polycarbonate protective films, a slit spacing of 0.75 mm or less was used as the criterion for pass/fail evaluation.

### e) Polarization Leakage

A curved polarizing plate, made by thermally bending the polarizing laminate, was placed over a flat polarizing plate such that their polarization axes were perpendicular to each other. Fluorescent light was applied from the flat polarizing plate side, and whether light leaked through was visually observed.

### Example 2

Except for replacing the protective layer on one side with a 200 μm-thick polycarbonate protective film without the stretching process, the procedure was carried out in the same manner as in Example 1.

### Example 3

Except for replacing the protective layers on both sides with 320 μm-thick polycarbonate protective films produced using a device capable of continuously performing melt extrusion and stretching of polycarbonate resin at a stretch ratio of 1.7×, the procedure was carried out in the same manner as in Example 1.

### Example 4

Except for replacing one protective layer with a 320 μm-thick polycarbonate protective film produced using a device capable of continuously performing melt extrusion and stretching of polycarbonate resin at a stretch ratio of 1.7×, and replacing the other protective layer with a 280 μm-thick polycarbonate protective film without the stretching process, the procedure was carried out in the same manner as in Example 1.

### Example 5

Except for replacing one protective layer with a 200 μm-thick polycarbonate protective film without the stretching process and changing the thickness of the cured adhesive layer to 5 μm, the procedure was carried out in the same manner as in Example 1.

### Example 6

Except for replacing one protective layer with a 700 μm-thick polycarbonate protective film produced using a device capable of continuously performing melt extrusion and stretching of polycarbonate resin at a stretch ratio of 1.3×, and replacing the other protective layer with a 700 μm-thick polycarbonate protective film without the stretching process, the procedure was carried out in the same manner as in Example 1.

### Example 7

One protective layer was a 275 μm-thick polyamide protective film made by a melt extrusion method in which an amorphous transparent polyamide resin composed of aliphatic and alicyclic components was melted, extruded, cooled with cooling rolls, and wound using a take-up machine. The other protective layer was made by cutting the above polyamide protective film into 40 cm squares, fixing all four sides with clamps, maintaining it at the Tg temperature (midpoint in DSC measurement) for 20 minutes, stretching it uniaxially at a stretch ratio of 1.5× and a stretching speed of 2 m/min, and cooling it at room temperature for 30 minutes while keeping it under tension, resulting in a 200 μm-thick polyamide protective film.

Except for these changes, the polarizing laminate was prepared in the same manner as in Example 1. Punching was performed as in Example 1, and thermal bending was also performed using a continuous thermal bending device as in Example 1. When a transparent protective sheet made of polyamide resin was used as the protective layer, the ambient temperature was set to 136° C. The female mold was a partial sphere corresponding to an 8R curvature (radius approximately 65.6 mm) with a surface temperature of 135° C. The pressing time with the silicone rubber male mold was 4 seconds, and suction to the female mold was maintained for 5 minutes in an atmosphere of hot air at 166° C.

The protective film of the thermally bent punched pieces manufactured as described above was removed, and the pieces were placed in the mold cavity of an injection molding machine. Injection molding was performed using molten polyamide resin (product name: Grilamid TR90, manufactured by EMS-CHEMIE). The injection molding conditions were as follows: resin temperature 280° C., injection filling speed 30 mm/s, holding pressure 30 MPa, mold temperature 80° C., and cooling time 30 seconds. The injection cycle was set to 70 seconds, resulting in an injection-molded lens with a thickness of 2.2 mm.

### Comparative Example 1

Except for replacing both protective layers with 320 μm-thick polycarbonate protective films produced using a device capable of continuously performing melt extrusion and stretching of polycarbonate resin at a stretch ratio of 2×, the procedure was carried out in the same manner as in Example 1.

### Comparative Example 2

Except for replacing one protective layer with a 400 μm-thick polycarbonate protective film produced using a device capable of continuously performing melt extrusion and stretching of polycarbonate resin at a stretch ratio of 1.8×, and replacing the other protective layer with a 300 μm-thick polycarbonate protective film without the stretching process, the procedure was carried out in the same manner as in Example 1.

### Comparative Example 3

Except for replacing both protective layers with 700 μm-thick polycarbonate protective films produced using a device capable of continuously performing melt extrusion and stretching of polycarbonate resin at a stretch ratio of 1.5×, the procedure was carried out in the same manner as in Example 1.

### Comparative Example 4

Except for changing the thickness of the cured adhesive layer to 40 μm, the procedure was carried out in the same manner as in Example 1.

### Comparative Example 5

Except for replacing one protective layer with a 320 μm-thick polycarbonate protective film produced using a device capable of continuously performing melt extrusion and stretching of polycarbonate resin at a stretch ratio of 1.7×, and replacing the other protective layer with a 100 μm-thick polycarbonate protective film without the stretching process, the procedure was carried out in the same manner as in Example 1.

### Comparative Example 6

Except for replacing both protective layers with 200 μm-thick polycarbonate protective films without the stretching process, the procedure was carried out in the same manner as in Example 1.

### Comparative Example 7

Except for setting the stretching speed to 4 m/min and replacing both protective layers with 320 μm-thick polyamide protective films, the procedure was carried out in the same manner as in Example 7.

The evaluation results of the examples and comparative examples prepared as described above are shown in Table 1 below.

TABLE 1

| | Protective layer 1 | | | | | | | | | | |
|---|---|---|---|---|---|---|---|---|---|---|---|
| | | | | | | Optical | | | | | |
| | | | | | | distortion | Protective layer 2 | | | | |
| | Type | | | | | Slit | Type | | | | |
| | of | Thickness | Retardation nm | | | pitch | of | Thickness | Retardation nm | | |
| | resin | μm | L | C | R | mm | resin | μm | L | C | R |
| Example 1 | PC | 200 | 4400 | 4300 | 4400 | 0.35 | PC | 200 | 4400 | 4300 | 4400 |
| Example 2 | PC | 200 | 4400 | 4300 | 4400 | 0.35 | PC | 200 | 10 | 10 | 10 |
| Example 3 | PC | 320 | 4000 | 4000 | 4000 | 0.75 | PC | 320 | 4000 | 4000 | 4000 |
| Example 4 | PC | 320 | 4000 | 4000 | 4000 | 0.75 | PC | 280 | 10 | 10 | 10 |
| Example 5 | PC | 200 | 4400 | 4300 | 4400 | 0.35 | PC | 200 | 10 | 10 | 10 |
| Example 6 | PC | 700 | 3300 | 3300 | 3300 | 0.60 | PC | 700 | 10 | 10 | 10 |
| Example 7 | PA | 200 | 4400 | 4200 | 4400 | 0.75 | PA | 200 | 20 | 20 | 20 |
| Comarative | PC | 320 | 5700 | 5900 | 5600 | 1.20 | PC | 320 | 5700 | 5900 | 5600 |
| Example 1 | | | | | | | | | | | |
| Comarative | PC | 400 | 5600 | 5600 | 5700 | 1.55 | PC | 300 | 100 | 100 | 100 |
| Example 2 | | | | | | | | | | | |
| Comarative | PC | 700 | 5500 | 5600 | 5500 | 0.90 | PC | 700 | 5500 | 5600 | 5500 |
| Example 3 | | | | | | | | | | | |
| Comarative | PC | 200 | 4400 | 4300 | 4400 | 0.35 | PC | 200 | 4400 | 4300 | 4400 |
| Example 4 | | | | | | | | | | | |
| Comarative | PC | 320 | 4000 | 4000 | 4000 | 0.75 | PC | 100 | 20 | 20 | 30 |
| Example 5 | | | | | | | | | | | |
| Comarative | PC | 200 | 10 | 10 | 10 | 0.40 | PC | 200 | 10 | 10 | 10 |
| Example 6 | | | | | | | | | | | |
| Comarative | PA | 320 | 5600 | 5300 | 5600 | 0.95 | PA | 320 | 5600 | 5300 | 5600 |
| Example 7 | | | | | | | | | | | |

| | | Polarizing laminate | | | |
|---|---|---|---|---|---|
| | Optical | | | Optical | |
| | distortion | Adhesive | | distortion | |
| | Slit | layer | | | Slit |
| | pitch | Thickness | Polarization | Visual | pitch |
| | mm | μm | leakage | inspection | mm |
| Example 1 | 0.35 | 10 | ∘ | ∘ | 0.85 |
| Example 2 | 0.40 | 10 | ∘ | ∘ | 0.80 |
| Example 3 | 0.75 | 10 | ∘ | Δ | 1.05 |
| Example 4 | 0.45 | 10 | ∘ | ∘ | 0.85 |
| Example 5 | 0.40 | 5 | ∘ | ∘ | 0.80 |
| Example 6 | 0.40 | 10 | ∘ | ∘ | 0.80 |
| Example 7 | 0.45 | 10 | ∘ | ∘ | 0.85 |
| Comarative | 1.20 | 10 | ∘ | x | 1.15 |
| Example 1 | | | | | |
| Comarative | 0.50 | 10 | ∘ | x | 1.25 |
| Example 2 | | | | | |
| Comarative | 0.90 | 10 | ∘ | x | 1.10 |
| Example 3 | | | | | |
| Comarative | 0.35 | 40 | ∘ | x | 1.25 |
| Example 4 | | | | | |
| Comarative | 0.40 | 10 | ∘ | x | 1.25 |
| Example 5 | | | | | |
| Comarative | 0.40 | 10 | x | ∘ | 0.75 |
| Example 6 | | | | | |
| Comarative | 0.95 | 10 | ∘ | x | 1.20 |
| Example 7 | | | | | |

As shown in Table 1, it was revealed that the optical distortion of the protective layer, laminated on both sides of a uniaxially stretched polyvinyl alcohol resin film serving as the polarizing film through adhesive layers, also affects the optical distortion of the polarizing laminate. Specifically, when the slit spacing of the protective layer exceeds 0.75 mm, the slit spacing of the polarizing laminate increases beyond 1.05 mm, resulting in optical distortion that fails the visual inspection standards. It was also found that the optical distortion of the protective layer tends to worsen when the variation in retardation is large.

Additionally, it was found that, apart from the optical distortion of the protective layer, the optical distortion of the polarizing laminate also worsens when the adhesive layer thickness exceeds 40 μm, as shown in Comparative Example 4, or when the protective layer thickness decreases to 100 μm or less, as shown in Comparative Example 6.

### INDUSTRIAL APPLICABILITY

The present invention provides a polarizing laminate with uniform slit widths. This enables the easy provision of polarizing sheets with minimal optical distortion, equivalent to so-called military-grade standards.

1. A polarizing laminate comprising a uniaxially stretched polyvinyl alcohol resin film serving as a polarizing film, with transparent plastic sheets as protective layers laminated on both sides via adhesive layers, wherein, in optical distortion measured based on MIL-DTL-43511D, the difference between the maximum and minimum widths of gaps (slit spacing) formed by two adjacent slits in the polarizing laminate is 1.05 mm or less.

2. The polarizing laminate according to claim 1, wherein the difference between the maximum and minimum widths of gaps (slit spacing) formed by two adjacent slits in the protective layer of the polarizing laminate is 0.75 mm or less.

3. The polarizing laminate according to claim 1, wherein the retardation value of at least one protective layer is 3000 to 5000 nm.

4. The polarizing laminate according to claim 3, wherein the retardation value of the protective layer on the opposite side is less than 100 nm.

5. The polarizing laminate according to claim 3, wherein the difference between the maximum and minimum retardation values of at least one protective layer in the polarizing laminate is less than 300 nm.

6. The polarizing laminate according to claim 1, wherein the thickness of the protective layer is greater than 100 μm.

7. The polarizing laminate according to claim 1, wherein the thickness of the adhesive layer is less than 40 μm.

8. The polarizing laminate according to claim 1, wherein the protective layer is made of polycarbonate resin or polyamide resin.

9. A polarized lens for sunglasses using the polarizing laminate according to claim 1, wherein, in optical distortion measured based on MIL-DTL-43511D, the difference between the maximum and minimum widths of gaps (slit spacing) formed by two adjacent slits is 1.05 mm or less.
